(19) United States
(12) Patent Application Publication
(10) Pub. No.: US 2007/0010152 A1
(43) Pub. Date: Jan. 11, 2007

(54) Tarpaulin by using polyolefin group split yarn and method thereof

(76) Inventor: Hyuk-Chong Kwon, Seoul (KR)

Correspondence Address: HAHN LOESER & PARKS, LLP, One GOJO Plaza, Suite 300, AKRON, OH, 44311-1076, US

(21) Appl. No.: 10/569,521

(22) PCT Filed: Sep. 26, 2003
(86) PCT No.: PCT/KR03/01967

§ 371 Date: Feb. 24, 2006

(51) Int. Cl. B32B 27/12; B32B 5/02; B32B 27/04

(52) U.S. Cl. 442/189; 442/195; 442/203; 442/64; 442/131; 442/170

(57) ABSTRACT

The present invention relates to a tarpaulin by using a polyolefin group resin which is comprised of a polyolefin group woven cloth layer in which a polyolefin group resin is split, drawn and weaved and a polyolefin group resin coating layer manufactured by stacking the polyolefin group resin on both sides of the polyolefin group woven cloth, the tarpaulin comprising a polyolefin group yarn for constructing the polyolefin group woven cloth, the polyolefin group yam is split with a predetermined width and number, drawn by 7-8 times through a drawing plate, split firstly, performed secondly by a heat setting through a setting plate, twisted and then weaved, and the polyolefin group resin coating layer including a first polyolefin group resin coating layer caoted with a predetermined thickness and color and a second polyolefin group resin coating layer manufacured by stacking a melting polyolefin group resin on the first polyolefin group resin coating layer.

### TECHNICAL FIELD

The present invention relates to a tarpaulin by using polyolefin group split yarn and a method for manufacturing the same, and more particularly to, a tarpaulin by using polyolefin group split and a method for manufacturing the same in which a polyolefin group resin is slit, then firstly drawn, thereafter split and secondly set by heat, thereby weaving a woven cloth. An interception layer for intercepting heat and ultraviolet rays is coated firstly on the woven cloth by using a polyolefin group resin and then a layer for reinforcing the strength of the woven cloth is coated secondly on the interception layer by using the polyolefin group resin.

### BACKGROUND ART

Tarpaulins used for a waterproof tent are classified into PVC (polyvinyl chloride) tarpaulins and PE (polyethylene) tarpaulins according to used materials. Here, the PVC tarpaulin is prepared by coating PVC on both surfaces of a PET woven cloth comprised of multi-filament yarns, and the PE tarpaulin is prepared by coating LDPE (Low Density Polyethylene) on both surfaces of HDPE (High Density Polyethylene) tape yarn. Processes for manufacturing the PVC tarpaulin are disclosed in detail in U.S. Pat. No. 4,298,645.

However, in the HDPE, it is nearly impossible to manufacture the woven cloth by means of the above patent method because basically, its melting tension for working is very large. That is, the tension at the melting state when working is closely related to drawability. Therefore, when the melting tension of the resin is maintained properly within the working range of filament, a good drawability can be obtained in the melting state. In general, the diameter of a nozzle used in the working equipment of a multi-filament is about 0.5 mm(500 μm) and it is about 10 μm after drawing the multi-filament, therefore, the change of the diameter is reduced by 50 times or more in comparison with that of an earlier multi-filament.

However, because the HDPE has very large melting tension, there is a limit in drawability. That is, in case of a mono-filament manufactured by using the HDPE, the ratio of the diameter between the nozzle and filament is changed by 20 times or less, therefore, it is very difficult to manufacture a multi-filament yarn.

Also, in general PE tarpaulin, there is a disadvantage that the ratio between the HDPE and LDPE is 60:40 on the average, when the ratio exceeds that average, the strength of the HDPE woven cloth layer is deteriorated steeply due to the heat being applied when performing an LDPE coating and the surface of the woven cloth does not smooth.

In order to improve the foregoing problems, a conventional PE tarpaulin by using an HDPE split yarn and a manufacturing method thereof filed by the applicant of the present invention will be described with reference to FIGS. 1 to 3.

FIGS. 1a to 1e are views illustrating processes for manufacturing a split yarn constructing a conventional PE tarpaulin and FIG. 2 is a cross-sectional view illustrating a structure of the conventional PE tarpaulin. Firstly, processes for manufacturing the HDPE split yarn will be described with reference to FIG. 1.

At first, as shown in FIG. 1a, a high density polyethylene resin 20 is slit to several strands 22 by using a cutter and thereafter a surface of each slit tape yarn is incised with a proper size longitudinally through a splitting process, thereby obtaining a split yarn, as shown in FIG. 1b. Next, by using a drawing plate 26, the split yarn 24 is drawn about 7-8 times in length. Thereafter, the drawn split yarn 24 is passed through a setting plate 28 in order to maintain the drawn state. Accordingly, the drawn split yarn 24 is maintained as it is. Next, several strands of split yarns 24 is twisted by several times, thereby obtaining a twisted spit yarn 30, as shown in FIG. 1e.

Next, the manufactured PE split yarn 30 is formed to a woven cloth through a weaving process. A cross-sectional view of the tarpaulin manufactured by using the split yarn 30 is illustrated at FIG. 2. According to the conventional PE tarpaulin structure, it is comprised of an HDPE woven cloth layer 30 in which an HDPE yarn is slit to several strips, drawn, twisted by several times and weaved, and LDPE coating layers 32 and 32′ manufactured by stacking an LDPE resin on both sides of the HDPE woven cloth layer 30. For convenience's sake, the split yarn and HDPE woven cloth layer are depicted by the same reference number.

However, in the conventional tarpaulin manufacturing method by using the HDPE split yarn, as described above, there is a problem: in the process of FIG. 1b, the HDPE yarn which is slit to several strips is split and then drawn, as shown in FIG. 1c, however, in this case, when drawing the yarn, a large number of yarns are disconnected due to the incised portions formed to each slit strand, and consequently, it is impossible to manufacture a good product.

On the other hand, FIGS. 3a to 3c are views illustrating processes for manufacturing a PE tarpaulin according to the conventional art. When the HDPE woven cloth weaved with a split yarn 40 is carried with a conveyor, as shown in FIG. 3a, a high temperature LDPE resin with a melting state is stacked on an upper surface of the HDPE woven cloth. The LDPE resin supplied to the HDPE woven cloth is passed through a pair of rollers constructed by a cooling roller and a pressing roller and adhered to the HDEP resin in the melting state, thereby forming an upper LDPE coating layer 42.

Next, a high temperature LDPE resin is stacked to a lower side of the HDPE woven cloth and simultaneously the LDPE resin supplied to the HDPE woven cloth is passed through a pair of rollers constructed by a cooling roller and a pressing roller and adhered to the HDEP resin in the melting state, thereby forming a lower LDPE coating layer 42′. As a result, a tarpaulin as shown in FIG. 3b is manufactured. Both ends of the coated tarpaulin are cut and then wound to a bobbin, so a finished product or a semi-finished product is prepared.

Referring to FIG. 3c, in the PE tarpaulin manufactured by the above processes, when the PE tarpaulin is used for forming a thick LDPE coating layer, a second coating layer is formed at the outer surface of the LDPE layer. In order to enhance appearance of the PE tarpaulin and prevent strength of the HDPE woven cloth from deteriorating due to the heat of the melted LDPE with a constant volume or more, the melted LDPE resin is stacked on the upper surface of the first LDEP coating layer 42 and also on the lower surface of the first LDPE coating layer 42′, thereby forming the second LDPE coating layers 44 and 44′, that is, a tarpaulin with a double-coating structure.

However, as shown in FIG. 3c, according to the tarpaulin manufactured by the conventional tarpaulin manufacturing method, there is a disadvantage that a plurality of recess portions are founded at the points (the first coating layer 42 and the woven cloth layer 40 are met) A formed by knots. It is called as a crater phenomenon. This phenomenon cannot be removed because the thickness of the second coating layer 44 coated to the first coating layer 42 is the same as that of the first coating layer 42.

These portions are represented as recess points, and when viewing the points through the naked eyes, the finished product looks like a product having defects. Accordingly, although the points are not related to the quality of the product, the points affect the appearance of the product.

Also, in general, a double-structure tarpaulin is manufactured by folding two tarpaulin woven cloths in order to enhance its tear strength. In this case, not only the crater phenomenon is severely increased and but also the prominence and depression phenomenon is generated on the surface of the tarpaulin, so that the appearance of the product is defiled.

### DISCLOSURE OF THE INVENTION

An object of the present invention is to provide a polyolefin group tarpaulin by using a polyolefin group split yarn which provides an effect like a multifilament yarn. The polyolefin group resin is cheap in price and processed easily, and the equipment for processing the resin is not complicate, so the cost for equipment is also cheap in price. By using the polyolefin group yarn, a tape yarn is manufactured, then slit and drawn firstly, and thereafter the yarn which is drawn and increased its strength is split and then secondly set by heat.

Another object of the present invention is to provide a polyolefin group tarpaulin by using a polyolefin group split yarn which prevents a crater phenomenon like producing recess points on the polyolefin group woven cloth layer from generating due to the heat applied when coating the polyolefin group resin such as an LDPE and the like and has an effect for intercepting heat and ultraviolet rays by forming a polyolefin group resin layer having a structure processed by a first coating treatment with a predetermined thickness and color, for example, black color, and thereafter forming a polyolefin group resin layer having a structure processed by a second coating treatment with a predetermined thickness, thereby enhancing the appearance of the tarpaulin, capable of intercepting heat and ultraviolet rays and improving its strength.

Another object of the present invention is to provide a method for manufacturing a polyolefin group tarpaulin by using a polyolefin group split yarn which has a smooth and clean surface, improves the strength of the tarpaulin entirely, enhances the appearance of the tarpaulin and intercepts heat and ultraviolet rays by slitting and then firstly drawing the polyolefin group resin, splitting the yarn which is extended and increased its strength, setting secondly the split yarn by heat through a drawing plate, forming a polyolefin group woven cloth by twisting the yarn which is set by heat and maintained, forming a polyolefin group resin coating layer on both sides of the polyolefin woven cloth layer by firstly coating with a predetermined thickness and color, for example, black color, and forming a polyolefin group resin layer to the outside of the first polyolefin resin coating layer by secondly coating.

In order to provide the above object, there is provided a tarpaulin by using a polyolefin group resin which is comprised of a polyolefin group woven cloth layer in which a polyolefin group resin is slit, drawn and weaved and a polyolefin group resin coating layer manufactured by stacking the polyolefin group resin on both sides of the polyolefin group woven cloth, the tarpaulin comprising: a polyolefin group yarn for constructing the polyolefin group woven cloth, the polyolefin group yarn slit with a predetermined width and number, drawn by 7-8 times in length through a drawing plate, split firstly, set secondly by heat through a setting plate, twisted and then weaved, and the polyolefin group resin coating layer including a first polyolefin group resin coating layer coated with a predetermined thickness and color and a second polyolefin group resin coating layer manufactured by stacking a melting polyolefin group resin on the first polyolefin group resin coating layer.

Preferably, a high strength polyolefin group resin or a polypropylene yarn is positioned at every 3 to 5 split yarns among the plural slit polyolefin yarns resins which have a predetermine width, respectively.

More preferably, a thickness of the second coating layer is above twice than that of the first coating layer.

More preferably, the first coating layer is coated with a block color or added with a black pigment in order to intercept ultraviolet rays

More preferably, the first coating layer performs a function of a heat interception layer for intercepting heat applied when forming the second coating layer.

In another aspect of the present invention, there is provided a method for manufacturing a tarpaulin by using a polyolefin group yarn which includes steps of slitting, then drawing a polyolefin group resin, manufacturing a polyolefin group woven cloth by weaving the slit and drawn yarn, stacking a melting polyolefin group resin on both sides of the polyolefin group woven cloth layer and thereby forming a polyolefin group coating layer, the method comprising the steps of: splitting the polyolefin yarn which is slit with a predetermined width and number and firstly drawn by 7-8 times in length, setting secondly the polyolefin group split yarn by heat, twisting and weaving the split yarn maintained as a constant temperature through the heat setting in the woven cloth forming step, forming a first polyolefin group resin coating layer with a predetermined thickness and color on an upper and a lower surfaces of the weaved woven cloth, and forming a second polyolefin group resin coating layer by stacking a melting polyolefin group resin with a predetermined thickness on the outside of the first polyolefin resin coating layer.

### BRIEF DESCRIPTION OF THE DRAWINGS

FIGS. 1a to 1e are views illustrating processes for manufacturing a split yarn constructing a conventional PE tarpaulin,

FIG. 2 is a cross-sectional view illustrating a structure of the conventional PE tarpaulin,

FIGS. 3a to 3c are views illustrating processes for manufacturing a PE tarpaulin according to the conventional art,

FIGS. 4a to 4e are views illustrating processes for manufacturing a split yarn constructing a polyolefin group tarpaulin in accordance with the present invention,

FIG. 5 is a cross-sectional view illustrating a structure of the polyolefin group tarpaulin in accordance with the present invention.

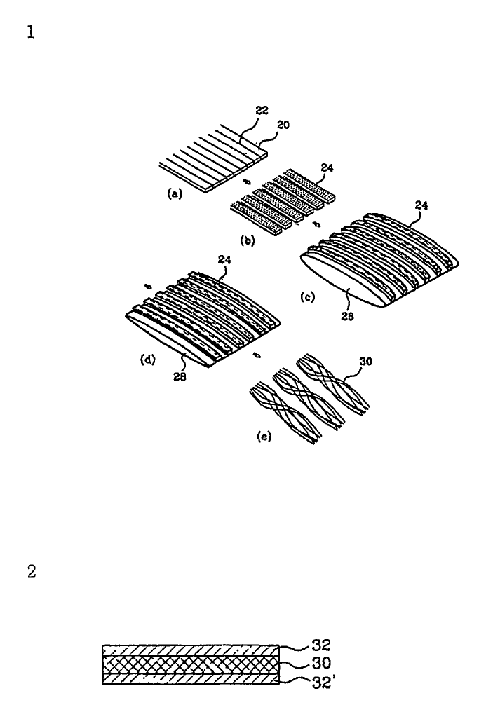

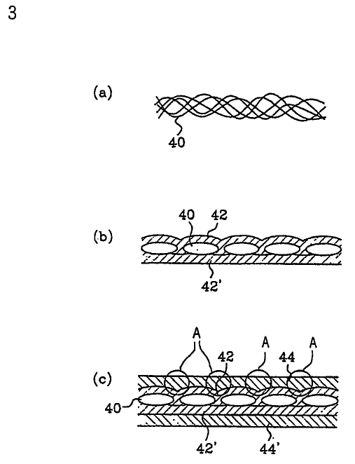

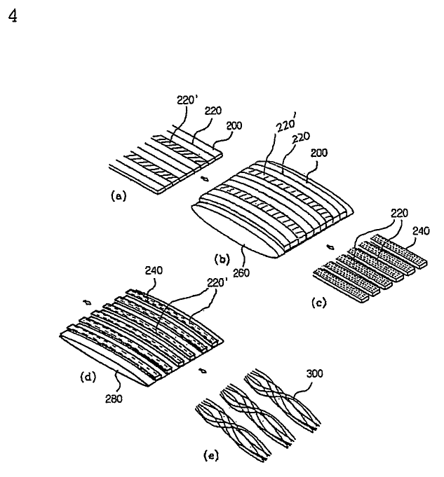

### BEST MODE FOR CARRYING OUT THE INVENTION

A tarpaulin by using a polyolefin group split yarn and a method for manufacturing the same in accordance with the present invention will now be described in detail with reference to the accompanying drawings.

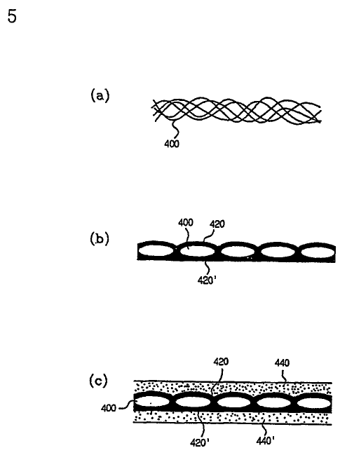

FIGS. 4a to 4e are views illustrating processes for manufacturing a split yarn constructing the polyolefin group tarpaulin in accordance with the present invention and FIG. 5 is a cross-sectional view illustrating a structure of the polyolefin group tarpaulin in accordance with the present invention. Firstly, processes for manufacturing the polyolefin group split yarn will be described with reference to FIG. 4.

Referring to FIG. 4a, a polyolefin group resin 200 is firstly slit to several strands 220 by using a cutter and thereafter the several strands 220 are firstly drawn by using a drawing plate 260, as shown in FIG. 4b. Thereafter, the surface of the slit and drawn each tape yarn is split with a constant size, thereby forming a split yarn, as shown in FIG. 4c. Next, by using a setting plate 280, the split yarn 240 is secondly set by heat, thereby maintaining the split yarn 240 with a constant temperature, as shown in FIG. 4d. Accordingly, the split yarn 240 maintains its drawn state. Next, each split yarn is twisted by several times, thereby manufacturing a twisted split yarn 300, as shown in FIG. 4e.

Next, the polyolefin group split yarn 300 manufactured by above method is weaved to a woven cloth through a weaving process.

The above processes will be described in detail as follows:

1) Resin is slit longitudinally (Slitting).

2) The slit resin is placed on a drawing plate in which its temperature sequentially increases up to 100° C. from 50° C. and its length is about 1 m, and then when the resin is drawn, it is extended by 7-8 times in length by heat. At this time, the strength of the resin (film, correctly speaking) is increased and its physical characteristic is enhanced.

3) The slit and drawn yarn (a yarn is a thread which is slit from the film and its diameter is in general 30 denier or more) is split longitudinally.

4) When the drawn yarn is exposed at the hot outside temperature during a long time after performing a press coating and manufacturing the finished goods, its length is reduced and contracted, thereby deteriorating its physical characteristic and appearance. In order to prevent from these problems, the drawn yarn is passed through a thermal plate with about 100° C. At this time, its physical characteristic is set.

5) The split yarn obtained from the above process is self-twisted in order to enhance its appearance and strength by a twisting process.

Referring to FIG. 4a, there is another characteristic according to the present invention, that is, several slit resins of the polyolefin group resin 200 (among split yarns divided several strands) are formed by a polyolefin group resin with high strength or a polypropylene yarn. That is, the polyolefin group resin with high strength or the polypropylene yarn 220-1 is positioned at every 3 to 5 split yarns one by one (that is, among a plurality of warps, one is replaced with the polyolefin group resin or the polypropylene yarn at every 3 to 5 split yarns), thereby reinforcing the tearing strength of the woven tarpaulin.

Also, according to the present invention, the resin is slit, then drawn by using firstly the drawing plate and thereafter split. Next, the split yarn is secondly passed through a thermal setting plate and then the yarn having an increased strength is twisted, thereby manufacturing the woven cloth. At this time, when weaving the split yarn, its strength is maintained. If a yarn is not split, it does not twisted smoothly in the twist process. Because the split yarn can be weaved densely per unit area (the width of the thread is about 1 mm), the densely product can be weaved and then the strength of the product is increased. That is, each split yarn can be wounded and weaved like a multi-filament yarn. By this, a tarpaulin with high strength can be manufactured by using a PE and the like in which the price of its manufacturing equipment is far cheap more than that of the multi-filament yarn.

On the other hand, the polyolefin group resin includes not only PE(Polyethylene-High Density PE, Low Density PE) but also EVA (Ethylene Vinyl Acetate Copolymer) and EMA (Ethyl methacrylate) and the like. All the above materials are recyclable and harmless material certified by FDA in U.S.A.

Also, FIGS. 5a to 5c are views illustrating processes for manufacturing a polyolefin group tarpaulin in accordance with the present invention. When the polyolefin group woven cloth weaved by the split yarn 400 is carried with a conveyor, as shown in FIG. 5a, a melting state high temperature polyolefin group resin is stacked on an upper surface of the polyolefin group woven cloth. Then the polyolefin group resin is passed through a pair of rollers comprised of a cooling roller and a pressing roller and adhered to the woven cloth in the melting state, thereby forming an upper polyolefin group resin coating layer 420.

Next, a high temperature polyolefin group resin is stacked to a lower side of the polyolefin group woven cloth and simultaneously the resin supplied to the polyolefin group woven cloth is passed through a pair of rollers constructed by a cooling roller and a pressing roller and adhered to the woven cloth in the melting state, thereby forming a lower polyolefin group coating layer 420′. As a result, a tarpaulin as shown in FIG. 5b is manufactured. Both ends of the coated tarpaulin are cut and then wound to a bobbin, so a finished product or a semi-finished product is prepared. The above processes are first coating processes, and the polyolefin group coating layers 420 and 420′ may have a predetermined color, for example, black color, a predetermined thickness (about 20 μm to 30 μm) and an effect for intercepting heat. Especially, in case of black color, the ultraviolet is completely intercepted.

Also, the polyolefin group coating layers 420 and 420′ with the predetermined color play several roles that the intensity of the high strength polyolefin group tape yarn or PP yarn 220-1 added as one among the characteristics of the present invention is maintained and heat is intercepted completely. Since the polyolefin group tape yarn or PP yarn 220-1 is weak by ultraviolet rays, in order to intercept ultraviolet rays completely, the predetermined color coating layer, for example, the black color coating layers 420 and 420′ play an important role which maintains the strength of the polyolefin group woven cloth. The black coating layers 420 and 420′ may be formed by adding pigments to the first coating polyolefin group resin layer.

In general, ultraviolet intercepting agent is added to the resin layer, however, in this case, since the ultraviolet intercepting agent includes oil components, there is a problem that when coating the polyolefin group resin to the woven cloth, both materials may not be adhered to each other (delamination phenomenon), whereas in the present invention, since both materials are adhered to each other by adding a constant volume of pigment to the polyolefin group resin, not the ultraviolet rays interception agent. So that, the coated tarpaulin has effects for intercepting heat and protecting the polyolefin (including an HDPE) split yarn, a polyolefin group tape yarn or a PP yarn woven cloth layer positioned inwardly from ultraviolet rays. Especially, the PP is very weak to the ultraviolet rays and so has a good effect due to the coating layer.

Referring to FIG. 5c, in the polyolefin group tarpaulin manufactured by the above process, the polyolefin group resin coating layer (for example, an LDPE, but not limited that) is coated thickly, that is, a second coating layer is formed on the outer surface of the polyolefin group resin coating layer (generally, about 70 to 80 μm or more). By this, in order to enhance the appearance of the tarpaulin and make a product having a constant thickness as occasion demands, a tarpaulin of a double-coating layer structure is completed by stacking a melting polyolefin group resin on an upper surface of the first polyolefin group resin coating layer 420 through the above-described method, thereby forming a second polyolefin group coating layer 440, and stacking a melting polyolefin group resin on a lower surface of the first polyolefin group resin coating layer 420′ thereby forming a second polyolefin group coating layer 440′.

In the completed polyolefin group tarpaulin, the first polyolefin group resin coating layer with a predetermined color, for example, black color is covered completely by the second coating layer, so that it cannot be seen from the outside. Although in the appearance of the tarpaulin, it has not a difference when comparing with it to the conventional tarpaulin, it intercepts the heat applied by the melting process and ultraviolet rays completely. Also, since the coating layers are formed firstly and secondly with a different thickness, a crater phenomenon does not occur due to the recess portions.

The polyolefin group resin coating layer, as a characteristic of the present invention, will be more described in detail. It is well known that it is realistically impossible to melt polyethylene/polypropylene(PE/PP) with a thickness of 80 to 100 μm and then coat it on a woven cloth layer. When the melting resin having such thickness is contacted to the woven cloth (the material of the woven cloth is the same as that of the melting resin and its strength is more power than that of the melting resin), the strength of the woven is deteriorated significantly due to the heat. Although it is necessary to manufacture a product having a thickness of a constant thickness or more, it cannot be manufactured. Accordingly, firstly, a coating is performed by a thickness of 30 to 50 μm. (And then after curing the coating layer), by this, the first coating layer performs a heat interception function to the heat applied when performing the second coating. Consequently, a product having a thickness of 200 μm or more can be manufactured. At this time, a black color coating layer (pigment can be inserted) may be formed to the inside of the first coating resin instead of the ultraviolet rays interception agent having oil components, thereby obtaining the ultraviolet interception effect.

Also, as above, if the coating process is not divided into first and second processes, the melted resin is inserted deeply to the recess points crossing the yarns on the woven cloth, thereby generating a crater phenomenon showing like a crater (like a well). However, by using the above method of the present invention, a crater generated when performing the first coating process is filled naturally when performing the second coating process, thereby enhancing significantly the appearance of the product.

The second polyolefin resin coating layer (LDPE, LLDEP(Linear LDPE), EMA, EVA and soft PP and the like can be used as the raw material of the second polyolefin resin coating layer) has an effect that various colors can be freely added.

As the present invention may be embodied in several forms without departing from the spirit or essential characteristics thereof, it should also be understood that the above-described embodiments are not limited by any of the details of the foregoing description.

### INDUSTRIAL APPLICABILITY

As discussed earlier, in accordance with the present invention, there is an advantage that a tearing strength can be improved significantly compared to the conventional tarpaulin and the manufacturing method. Further, a tarpaulin having a smooth structure removed the crater phenomenon can be manufactured.

Also, a tarpaulin having a more high strength and compact structure can be weaved by using the yarn which is slit, then drawn, split and set by heat. Further, a coating layer is formed in order to completely intercept heat applied when performing the second coating layer after forming the first coating layer and ultraviolet rays applied from the outside, thereby increasing the strength of the tarpaulin.

What is claimed is:

1. A tarpaulin by using a polyolefin group resin which is comprised of a polyolefin group woven cloth layer in which a polyolefin group resin is slit, drawn and weaved and a polyolefin group resin coating layer manufactured by stacking the polyolefin group resin on both sides of the polyolefin group woven cloth, the tarpaulin comprising:
a polyolefin group yarn for constructing the polyolefin group woven cloth, the polyolefin group yarn slit with a predetermined width and number, drawn by 7-8 times in length through a drawing plate, split firstly, set secondly by heat through a setting plate, twisted and then weaved, and
the polyolefin group resin coating layer including a first polyolefin group resin coating layer coated with a predetermined thickness and color and a second polyolefin group resin coating layer manufactured by stacking a melting polyolefin group resin on the first polyolefin group resin coating layer.

2. The tarpaulin of claim 1, wherein a high strength polyolefin group resin or a polypropylene yarn is positioned at every 3 to 5 split yarns among the plural slit polyolefin yarns resins which have a predetermine width, respectively.

3. The tarpaulin of claim 1, wherein a thickness of the second coating layer is above twice than that of the first coating layer.

4. The tarpaulin of claim 1, wherein the first coating layer is coated with a block color or added with a black pigment in order to intercept ultraviolet rays

5. The tarpaulin of claim 1, wherein the first coating layer performs a function of a heat interception layer for intercepting heat applied when forming the second coating layer.

6. A method for manufacturing a tarpaulin by using a polyolefin group yarn which includes steps of slitting, then drawing a polyolefin group resin, manufacturing a polyolefin group woven cloth by weaving the slit and drawn yarn, stacking a melting polyolefin group resin on both sides of the polyolefin group woven cloth layer and thereby forming a polyolefin group coating layer, the method comprising the steps of:
splitting the polyolefin yarn which is slit with a predetermined width and number and firstly drawn by 7-8 times in length,
setting secondly the polyolefin group split yarn by heat,
twisting and weaving the split yarn maintained as a constant temperature through the heat setting in the woven cloth forming step,
forming a first polyolefin group resin coating layer with a predetermined thickness and color on an upper and a lower surfaces of the weaved woven cloth, and
forming a second polyolefin group resin coating layer by stacking a melting polyolefin group resin with a predetermined thickness on the outside of the first polyolefin resin coating layer.

7. The method of claim 6, wherein a high strength polyolefin group resin or a polypropylene yarn is positioned at every 3 to 5 split yarns among the plural slit polyolefin yarns resins which have a predetermine width, respectively.

8. The method of claim 6, wherein a thickness of the second coating layer is above twice than that of the first coating layer.

9. The method of claim 6, wherein the first coating layer is coated with a block color or added with a black pigment in order to intercept ultraviolet rays

10. The method of claim 6, wherein the first coating layer performs a function of a heat interception layer for intercepting heat applied when forming the second coating layer.
